(19) United States
(12) Patent Application Publication
(10) Pub. No.: US 2012/0317288 A1
(43) Pub. Date: Dec. 13, 2012

(54) SYSTEM AND METHOD FOR PUBLISHING CONTENT ON THE INTERNET

(75) Inventors: David Anthony Campana, Princeton, NJ (US); Shemimon Manlikudy Anthru, Dayton, NJ (US); Ishan Mandrekar, Monmouth Junction, NJ (US); Jens Cahnbley, West Windsor, NJ (US); Saurabh Mathur, Monmouth Junction, NJ (US); David Anderson, Florence, NJ (US)

(73) Assignee: Thomson Licensing

(21) Appl. No.: 13/579,706

(22) PCT Filed: Dec. 8, 2010
(86) PCT No.: PCT/US10/03111

§ 371 Date: Aug. 17, 2012

Related U.S. Application Data
(60) Provisional application No. 61/306,184, filed on Feb. 19, 2010.

(51) Int. Cl. G06F 15/173

(52) U.S. Cl. 709/225

(57) ABSTRACT

A method and system enables sharing content between a plurality of users over a communications network. A link to content that has been shared by a user is selected, the link includes at least one access characteristic defining a set of users able to access the content. A request signal including the at least one access characteristic associated with the content and at least one user characteristic associated with a requesting user over the communications network is transmitted for receipt by an authorization processor. A level of access available is determined for the content by comparing the at least one access characteristic and the at least one user characteristic in the request signal with a source of content specific authentication information including data representing content-specific access levels. Access to the requested content is provided via an internet interface to an output device in accordance with the determined level of access.

### CROSS-REFERENCE TO RELATED APPLICATIONS

This application claims the benefit of U.S. Provisional Application Ser. No. 61/306,184 filed 19 Feb. 2010, and is hereby incorporated by reference in its entirety for all purposes.

### FIELD

The present arrangement provides a system and method that enables content to be published and shared between users having different access rights.

### BACKGROUND

Content publishing on the Internet has become very popular in recent years. Blogs, social networking sites and user generated content aggregation sites have become main stream and provide users with many ways to access and share content. In one common scenario, a user publishes a link to a video they liked to a personal blog or social networking site. FIG. 1 illustrates an exemplary screenshot 100 whereby a user (user A) watches a video on a content aggregation site such as YOUTUBE®. When accessing a video display window 102 in which the video may be viewed, the website hosting the content provides a mechanism by which user A can share the content. For example, as shown in FIG. 1, a user can select a “share” button 104 which provides access to additional selectable links 106 enabling user A to select a social networking site (FACEBOOK®, MYSPACE®, etc) or other website and share the content on the selected social networking site. Selection of one of the respective links 106 embeds a link to the current video on the selected social networking or other website (e.g. his/her personal blog). Another user (user B) who accesses the site on which user A has embedded a content link, clicks on the embedded link to view the same content. Another exemplary sharing mechanism is shown in FIG. 2 which depicts a display image 200 generated by a second different content aggregation site, www.hulu.com, that enables a user to view content in display window 202. The user viewing the content is presented with selectable link 204 that, upon selection thereof, enables the user to copy code corresponding to the video being watched. The user may copy the embedding code allowing a link to the video to be embedded on another website.

While there are plenty of sites that enable sharing of hosted content such as those in FIGS. 1 and 2, there are content aggregation sites that do not allow linking to hosted content. An example of this type of site is NETFLIX®. This is a subscription based service that requires user authenticated access to view content that is hosted and has no content sharing option.

Video aggregation web sites like YOUTUBE®, Veoh, Hulu, etc. allow users to embed a link to a video on their blogs or social networking sites like FACEBOOK®. However, all content hosted by these services is freely accessible. Paid video streaming services like NETFLIX® or even video on demand services offered by a cable operator do not offer the ability to link those videos to a web site.

The mechanisms for sharing content described with respect to FIGS. 1A and 1B is beneficial when the content is unprotected and not subject to any rights management schemes. However, it presents significant issues when the content is subject to rights management schemes whereby only a particular subset of users has the ability to legally access the content. For example in certain cases, the video accessed by user A may only be available due to the existence of a paid subscription and thus not available to user B who may not have the same subscription. Therefore, allowing user B to watch the linked video may not be feasible in an economic sense. Therefore, a need exists to balance the desirous effects of content sharing via social networking such as obtaining more paid subscribers while protecting the rights of the entity that has generated or hosts/provides access to the content.

### SUMMARY

A mechanism is provided that allows a content provider to process a request from a user to watch video content that is embedded on a web page and, based on the subscription level, allow the user to watch either the entire content or a teaser/clip of the content. In the latter case, the content provider can also provide information on how to subscribe to the service/video so that a user can watch the full content.

In one embodiment, a method performed by an apparatus for sharing content between a plurality of users over a communications network is provided. A request signal for a link to content selected by a user is received. The content is displayable on a primary display device. The request signal includes the at least one access characteristic associated with the content identified by the link and at least one user characteristic associated with the requesting user is transmitted over the communications network for receipt by an authorization processor. The authorization processor determines a level of access available to the user for the content by comparing the at least one access characteristic and the at least one user characteristic in the request signal with content specific authentication information including data representing content-specific access levels. Access is provided, via an internet interface, to the requested content on a secondary display device in accordance with the determined level of access.

In another embodiment, a system for enabling access to shared content over a communications network is provided. A receiver receives a request signal requesting access to content shared on a website, the content is displayed on a primary display device and the request signal including at least one access characteristic associated with the content and at least one user characteristic associated with a requesting user over the communications network. An authorization processor is coupled to the internet interface and determines a level of access available for the content by comparing the at least one access characteristic and the at least one user characteristic in the request signal with content specific authentication information including data representing content-specific access levels. An internet interface is coupled to the authorization processor and provides access to the requested content on a secondary display device in accordance with the determined level of access.

In a further embodiment, a method of sharing content between a plurality of users over a communications network is provided. Content to be shared is selected from a source of content, the content is displayable on a primary display device. A link is generated by a share processor that corresponds to the selected content. The link including at least one access characteristic associated with the selected content identifying a level necessary to obtain access the selected content over a communications network. The generated link to the selected content is published at a location on the communications network enabling the plurality of users to request access to the selected content, the generated link being displayable on a secondary display device.

In another embodiment, a system for enabling access to shared content over a communications network is provided. A share processor generates a link corresponding to content selected by a user to be shared over a communications network, the content being displayed on a primary display device and the link includes at least one access characteristic associated with the selected content identifying a level necessary to obtain access to the selected content over a communications network. An internet interface is coupled to the share processor and publishes the generated link to the selected content at a location on the communications network enabling the plurality of users to request access to the selected content, the link is displayable on a secondary display device.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 depicts a prior art content sharing option available from a content aggregation website;

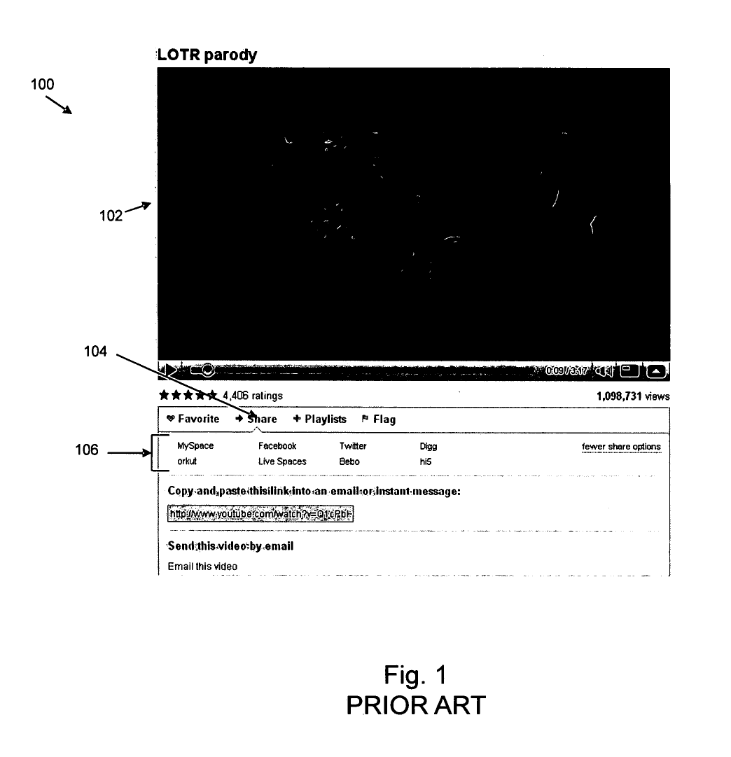

FIG. 2 depicts a prior art content sharing option available from a content aggregation website;

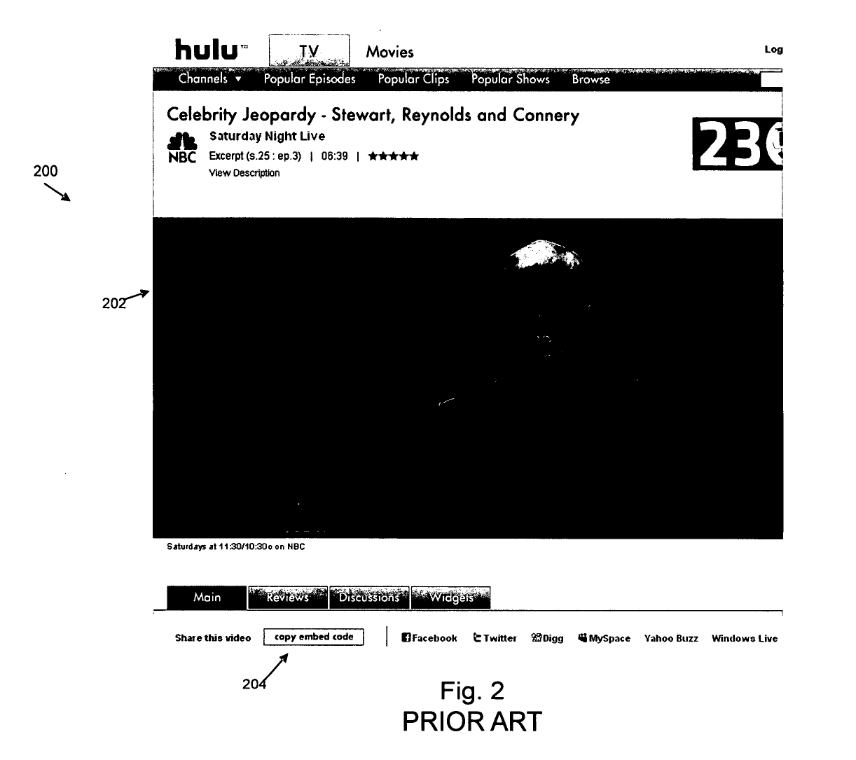

FIG. 3 is a block diagram of the system in accordance with an aspect of an embodiment;

FIG. 4 is an example of Favorite Videos displayed on a user's Facebook profile in accordance with an aspect of an embodiment;

FIG. 5 is an exemplary flow diagram detailing exemplary system operation in accordance with an aspect of an embodiment;

FIG. 6 is an exemplary flow diagram detailing exemplary system operation in accordance with an aspect of an embodiment; and

FIG. 7 is an exemplary flow diagram detailing exemplary system operation in accordance with an aspect of an embodiment.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

There exists a plethora of digital media content stored on various sources at various locations which are selectively accessible by users using a communication network. Content may include any audio, video or audiovisual data stored or broadcasted that is accessible to a user. Content may be stored or broadcasted by a provider website that is accessible via a browsing application executing on a computing device. Content may be encoded and formatted in a predetermined data format and is selectively decodable by a decoder device enabling access to the content. Content also may include access rights information defining an access level to be associated therewith. Access rights information may define the content as being at least one of (a) free to all users; (b) partially restricted; (c) entirely restricted and (d) accessible via a valid subscription agreement. Access rights information may also include device-specific access information defining at least one of (a) types of devices able to access the content and (b) number of devices able to access the content. Additionally, access rights information further include transfer rights information defining at least one of (a) if the content may be transferred to or shared with other users and (b) a transfer or sharing limit defining the number of times and/or users to which the content may be transferred or shared.

It is desirable for content providers to allow their content to be shared between and amongst various users. Thus, it is known to allow sharing of links to content which function to generate interest in other related content that has been generated or will be generated by the content provider. However, content providers often seek remuneration from users for the content they develop and post. Typically, this takes the form of a pay-per-view arrangement or a subscription service. Therefore, content providers may not be willing to allow complete access to content that may be shared by one user. The present system advantageously provides the benefit for sharing content while preserving the access rights controls that may be placed on the content by the content providers. The system advantageously enables sharing of content and, prior to enabling access by a user, automatically determines and authenticates whether or not the user should be granted access to the content. Furthermore, based on the determination, the system advantageously determines whether or not the requesting user is able to access the full content or a portion thereof and provides access to the correct level of content for the requesting user.

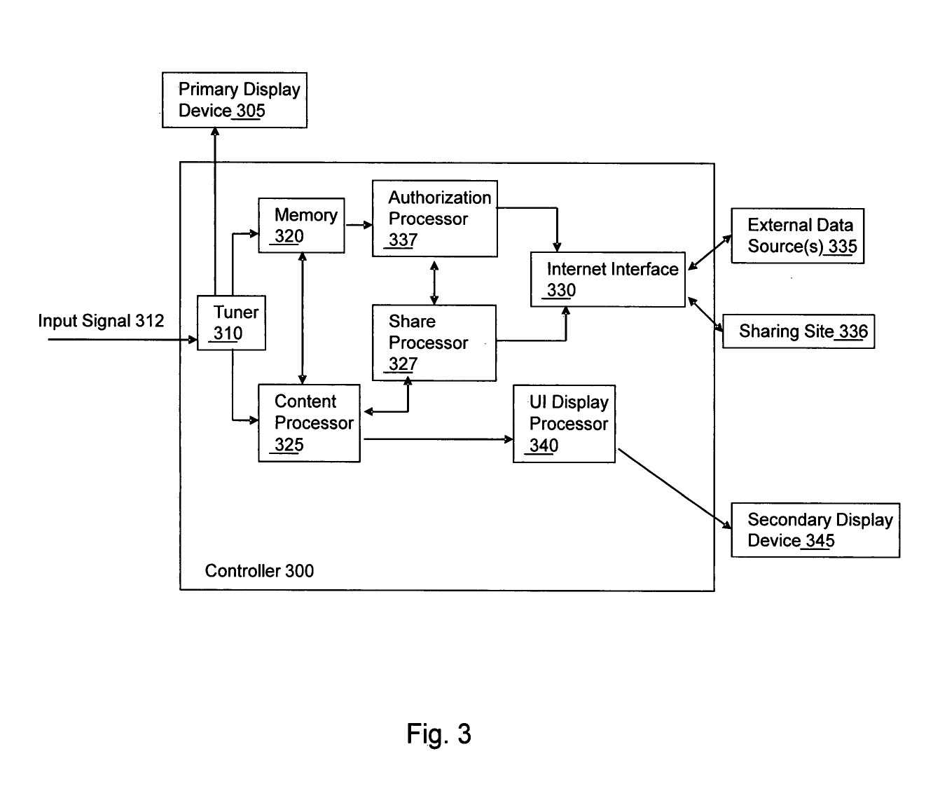

FIG. 3 is a block diagram of an aspect of the present system. The system includes a controller 300. The controller 300 may be a hardware component embodied in a set top box provided by a cable or satellite provider. The controller 300 includes a tuner 310 that selectively receives and tunes an input signal 312. The input signal may be a television broadcast signal formatted in a particular signal format such as those set forth by the Motion Pictures Experts Group (MPEG) or any other signal format used for encoding and transmitting audiovisual data and ancillary data associated with the audiovisual data. The tuner 310 tunes a desired program from the input signal 312 for display on a primary display device 305 in response to a control signal. Any ancillary data accompanying the tuned input signal 312 is decoded and stored in a memory 320. The ancillary data may include Electronic Program Guide (EPG) data or any other data encoded and transmitted with the input signal 312. Ancillary data accompanying the tuned input signal 312 may also include data representing access rights information identifying a level of access to the content.

The controller 300 further includes a content processor 325 coupled to both the tuner 310 and the memory 320. The content processor 325 identifies the program and/or channel tuned by tuner 310. The content processor 325 queries the EPG or other associated data stored in the memory 320 to identify characteristics that describe the content. The data derived from the query may be provided to and stored in the memory may be used to generate a description of the content as will be described below. Alternatively, the content processor 325 may engage an internet interface 330 which is coupled thereto and in response to a control signal received from a user using a control device (i.e. remote control—not shown) searches for and/or acquires content from at least one external data source 335. An exemplary external data source may include but is not limited to a content providing website or content aggregation website such as HULU®, hereinafter “internet content”. Upon locating and acquiring internet content from external data source 335 via the internet interface 330, the content processor 325 receives and stores in memory 320, data representing at least one of (a) description of the internet content, (b) location of the internet content (URL) and (c) access rights information associated with the internet content. Content processor 325 automatically generates user-selectable links for the acquired internet content and stores data representing the links in memory 320 for later use.

A share processor 327 is coupled to each of the content processor 325, memory 320 and the internet interface 330. The share processor 327 is responsive to a sharing control signal that instructs the system share content and/or internet content that is at least one of currently being accessed by a user and that is stored in memory 320. The sharing control signal received by the system may be generated by a user by at least one of (a) a user input device (keyboard, mouse, etc) and (b) selection of a button on a remote control device that initiates execution of a sharing application resident in system memory that automatically generates and publishes a link corresponding to content to be shared. Sharing control signal includes data representing at least one desired location to which the content being shared is to be published and formatting information that defines a format of how the content being shared will appear at the sharing location. In response to the control signal, the share processor 327 based on the data in the control signal, parses content description data, content location data and content access rights data stored in memory 320 which is associated with the content. A publication message is generated by share processor 327 using the format data included in the control signal and including at least one of location data, description data and access rights data. The publication message generated by share processor 327 is provided to the internet interface 330 which uses the sharing location data to access at least one share website 336 from which the content can be shared. An example of a share website 336 includes but is not limited to a social networking website and a personal blog. However, the share web site 336 can be any website or other location that is accessible by a plurality of different users who are authorized to access the location.

Share processor 327 may implement any numerous different techniques that enable a content provider (or service/network provider) to allow a subscriber to publish a link to content to a web site and then, determine what level of access a user has to the content. While sharing is described in the context of cable TV services, those of ordinary skill in the art can recognize the applicability of these techniques to other services (including online content services not limited to video). The techniques implemented by share processor 327 may be embodied as a set of instructions or algorithms that are, for example, hard coded on a circuit or embodied on a non-transitory storage medium.

Share processor 327 enables a user to publish a link to the content to some shared context (social networking site, email, etc.). Such a link can be published by a variety of methods:
1. Manually copied and pasted. For example, the user finds content on a content-specific web site and copies and pastes a “share” link to a social networking status update.
2. Manually posted from a content-specific web page via sharing site's application interface (API) (ex., the Facebook API). For example, the user finds content on a content provider web site and clicks a “Share on Facebook” link on the content-specific page. Alternatively, the user's cable set-top box (STB) displays a content-specific web page that is generated based on the channel the user is watching and clicks a “Share on Facebook” link.
3. Manually posted by pressing a remote control button via sharing site's API. For example, the user pre-configures the STB to point to a Facebook account. The user presses the “Share on Facebook” button on the STB remote control triggering the STB to post the link to Facebook via the Facebook API. Note that it is implementation specific regarding whether the STB communicates directly with Facebook's servers or through an intermediary server (ex., the cable provider's servers).
d. Automatically posted by STB via sharing site API. As the user views content, the activity is posted to a sharing site. A practical implementation of this can involve posting to a cable provider server that then exposes the data to social networking sites via a mechanism such as a social networking site specific application.

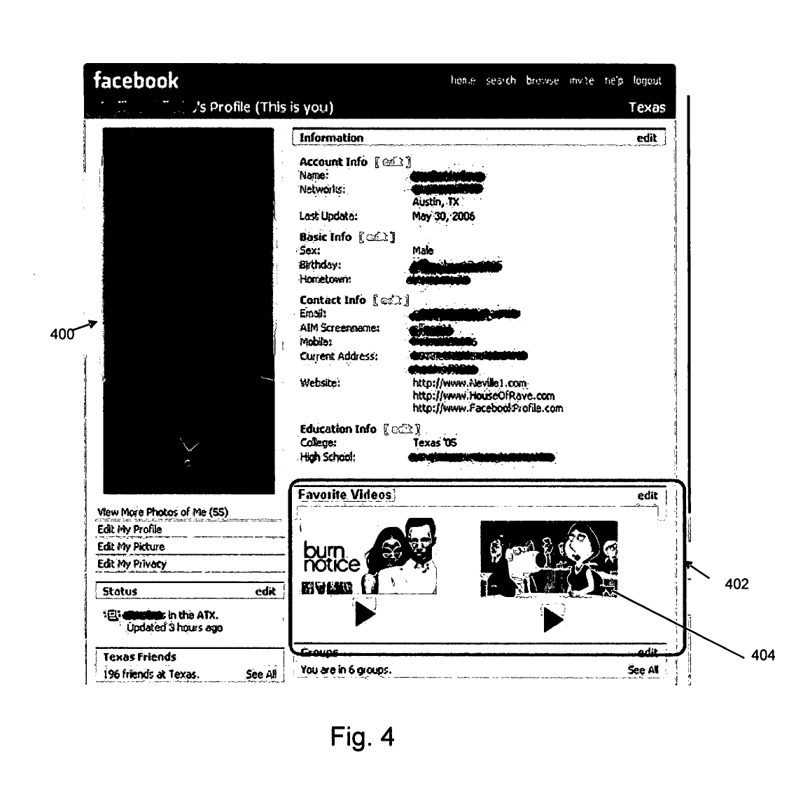

An exemplary screen shot of the publication of a link on a social networking site can be seen in FIG. 4. FIG. 4 depicts a user profile page 400. A “favorite videos” window is displayed on the user profile page that allows other users to get a glimpse into content the viewer may like. In accordance with any of the mechanism's above, when a user desires to share at least one piece of content, in this example, a digital audiovideo file, the system automatically publishes a link 402 to the content on the profile page of the sharing user. In this example, the link appears as a user-selectable thumbnail of a respective frame of the video content. However, this is for purposes of example only and the system may publish the link in any graphical or text form so long as it provides the user with the ability to select and request access to the content being shared. The system advantageously publishes a link to content which is designated as shared content. The use of FACEBOOK® provided above is for illustrative purposes only and is an example of a social networking website and corresponding applications. It should be noted that the system is able to share content with other types of applications and websites.

Referring back to FIG. 3, in another embodiment, share processor 327 provides data representing the shared content with the user selectable links to a user interface (UI) display processor 340. UI display processor 340 automatically formats the shared content link according to a predetermined format and causes the shared content link to be displayed on a secondary display device 345 which is separate and different from a primary display device (not shown). In one embodiment, the UI display processor 340 may provide the formatted user interface to the internet interface 330 which functions as a webserver and allows a browser executing on the secondary device 345 to be pointed to a hosted user interface allowing user access thereto. Once presented on the secondary device 345, a user may browse and navigate the shared content in order to select content that interests them. The user may select the associated link and the shared content associated with the selected link may be automatically acquired and displayed to the user on the secondary display device 345.

An authorization processor 337 is coupled to each of the internet interface 330, the share processor 327 and memory 320. Authorization processor 337 automatically determines what level of access, if any, a user attempting to access shared content on sharing site 336 should be granted. In response to selecting a link on a sharing site 336, an access request signal is communicated to authorization processor 337 via the internet interface 330. Upon receipt of the access request signal, share processor 337 compares access rights information associated with the shared content with a source of user authentication information stored in memory 320. User authentication information may include data identifying existence of a user subscription to at least one of the sources of the shared content (i.e. a NETFLIX subscription) or user subscription to the particular piece of shared content (i.e. user has purchased access on a pay-per-view arrangement). Access to the requested content is provided in response to the comparison made by authorization processor 337.

In one embodiment, when the user authentication information matches the access rights information, full access to the content may be provided to the requesting user. In another embodiment, the determination made by the authorization processor may result in a modified full access to the content being provided to the user. An example of modified full access may include segmenting data representing the content and inserting advertisement data between the segments such that the requesting user is able to access the entire content being shared but, in order to do so, is presented with advertisements sold by the content provider. In another embodiment, in response to the determination made by the authorization processor 337 whereby the requesting user is determined not to be able to access the shared content, the system may automatically provide a subset of the shared content to the requesting user. For example, if the shared content is a digital audiovisual file that is three minutes in length, the system may automatically extract a portion of the shared content file and provide a clip to the requesting user. Rules governing extraction of content for clip generation may be assigned by any of the content creator, the content provider, a service provider (e.g. cable/satellite provider) or by the user. Alternatively, the system may provide the requesting user with a message including information enabling the user to acquire appropriate access to the requested content. For example, a message including a link directing the requesting user to a subscription service website that enables the requesting user to obtain the appropriate level of access, for example by paying a fee.

The authorization processor 337 advantageously enables a content provider that provides on-demand content or content included as part of a paid subscription to check content rights when a user clicks on the published link and to redirect the user to content in an appropriate format based on the level of the user's rights. Examples of content rights and corresponding content formats include:

a. The link is to an episode of a network TV show. The user subscribes to a cable service from a provider that has an agreement with the network that owns the rights to the show to allow full streaming of the show to subscribers. The user is identified as a subscriber (by IP address, email login, etc.) and allowed to view the full content.

b. The link is to a movie. The user subscribes to a streaming video service that offers the movie to subscribers for full streaming. By providing subscription credentials, the user is given full access to the content. Mechanisms such as protocols that allow secure API authorization in a standard manner (e.g. OAuth) exist that enable user credentials to be shared between web sites and may be used in some embodiments of this invention for identifying external subscription services. In some embodiments, the link may point directly to the content provider, allowing the determination to be made by the content provider itself without a need to pass credentials between sites.

c. The user does not have access to the full content. In this case, the user can be shown a preview of the content—for example, a trailer for a movie—and/or may be presented with a form enabling the user to purchase rights to the content.

d. The user has device specific access rights. A user may or may not have rights to transfer the content to other devices—ex., a television or a mobile device. A user may have access to full content but at a diminished quality level (i.e. smaller screen, stereo audio, lower bit rate coding). Additionally, availability of content for separate devices can be different. For example, a user may have a particular subscription to a first device, while a second device may not have the same privileges. The situation where a subscription for a particular device will affect what is shown to the end user can be anticipated. For example, implementing the above (for example, a music MP3), it may turn out that a user has a subscription for a particular device such as a cell phone. Therefore, one can consider whether the receiving user has an appropriate subscription AND the device for which a subscription is provided for. Thus, if a user accesses a social networking site on their computer whereby the user receives a “clip” of interest from a second party, the user may not have the appropriate subscription to gain access to the full media service that the clip comports to (on their computer). However, the user may have a subscription on a different device (e.g. their cell phone), whereby the requested content would be transmitted to the user's cell phone enabling access to the content in accordance with the access rights of the user.

e. The user has content-type specific access that specifies how the content is accessed by the user. Content-type specific access sets forth access to the content at least one of (a) a particular bit-rate; (b) a particular frame rate; (c) a particular data format; (d) a particular transmission data speed and (e) a particular transmission pathway. For example, a content provider or content generator may allow full access to content but access may be restricted to a lower bit rate and/or frame rate thus reducing the quality at which the content is played back to the user.

In an embodiment whereby the authorization processor 337 restricts access to content in any way such that the content is unable to accessed in its full and original form, the authorization processor 337 generates an access message that is provide to the requesting user via the interne interface 330. The access message may include information enabling the user to acquire a different level of access to the content than is granted upon initial selection of the shared link on sharing website 336. For example, the message may include a user selectable link that brings the requesting user to a portal that enables the requesting user to obtain the different level of access for the requested content.

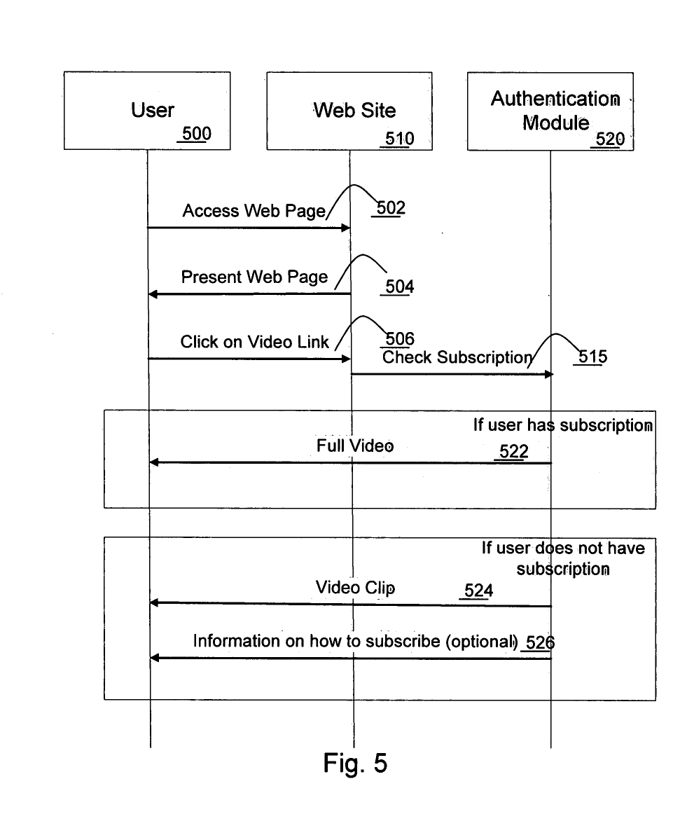

FIG. 5 is a time line diagram detailing the steps of the algorithm implemented by the system to determine if a user, who wishes to access shared content, is able to obtain access to the shared content. The workflow processes in FIG. 5 are actions that occur after the content has been published for sharing. For example, referring back to FIG. 4, the workflow in FIG. 5 begins when a requesting user accesses the social networking profile page of a user that has shared content and clicks on a user selectable link in window 402.

The workflow described herein occurs between a user 500, a website 510 that has content designated as “shared content” by an entity other than user 500 and an authentication module 520 which, for example, may be an executable application executing on the authorization processor 337 of FIG. 3. A user uses a web browser operating on a computing device (e.g. personal computer, laptop, smart phone, cell phone, etc) to browse in step 502 to a web site 510 that provides links to video content that is designated as “shared content”. This web site may be a social networking site such as Facebook with the video links provided via these techniques through a Facebook-specific application interface. In response to entering the URL for the website 510, the corresponding web page including the shared content is presented to the user 500 in step 504. An example embodiment is shown window 402 in FIG. 4 which shows a Favorites Video application that provides video links on a user's Facebook profile page. User 500 selects a link displayed on webpage 510 corresponding to the shared content in step 506. In response to selecting the link in step 506, a request signal requesting access to the shared content is transmitted to the system. The request signal includes access rights information and user authentication information. The request signal is transmitted in step 515 to authentication module 520. Authentication module 520 parses the request signal and determines whether or not the user has permission to view the video content. Exemplary user authorization/authentication may include determining a requesting user's cable subscription (for example, a user who subscribes to HBO can be given permission to stream HBO online content), by access to online services offering the content (for example, the user may be a Netflix member and have access to the content via the Netflix InstantWatch feature), or by some other means or combination of means. Another example of operation of the authorization module includes determining access rights in view of device-specific data and parameters that may govern rules relating to the types of devices on which the shared content maybe accessed. A further example of operation of the authorization module includes determining content-type specific access rights that may govern rules associated with any of the bit rate, frame rate and data format associated with the content being accessed.

In the instance that the requesting user is determined to have full access (e.g. a full subscription) to the video being requested, the full video content is transmitted/streamed to the user in step 522. In the instance that the requesting user is determined to not have full access (e.g. trial/partial/none subscription) to the video being requested, a subset of the requested video is presented to the user in step 524. For example, if the user does not have access, a video clip such as a trailer or advertisement for the full video content may be streamed to the user. In another embodiment, in the instance when a user is determined not to be able to access the full version of the requested content, the authentication module 520 may automatically transmit data including information on how the user can obtain full access rights to the requested content 526.

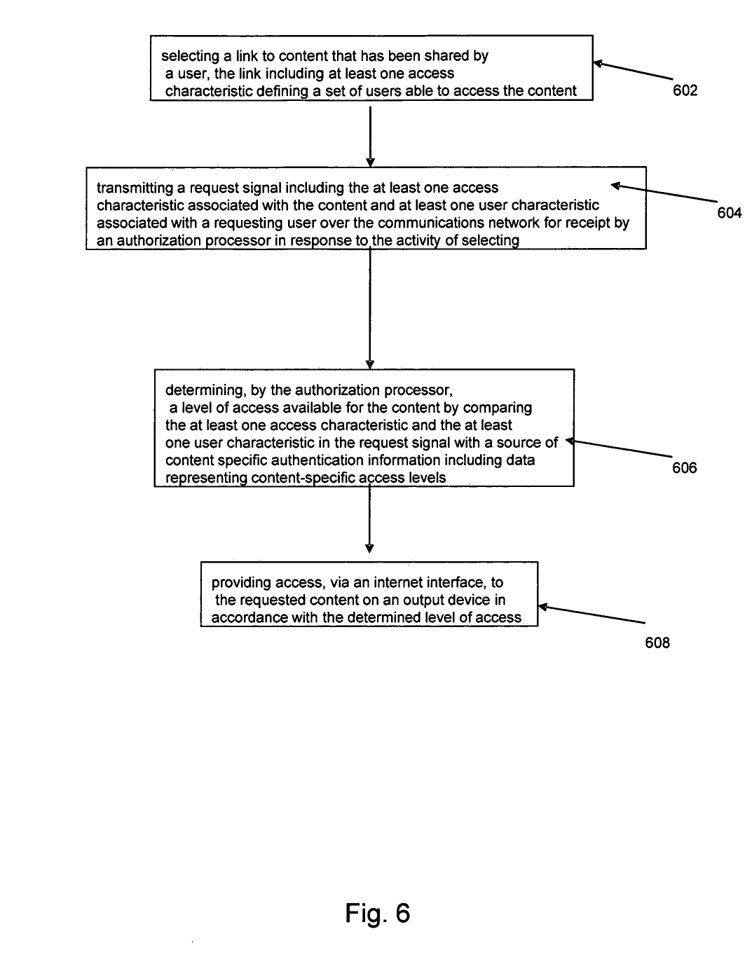

FIG. 6 details an exemplary operational algorithm implemented by the system that enables sharing of content between a plurality of users over a communications network. In step 602, a link to content that has been shared by a user is selected. The link includes at least one access characteristic defining a set of users able to access the content. In step 604, a request signal including the at least one access characteristic associated with the content and at least one user characteristic associated with a requesting user is transmitted over the communications network for receipt by an authorization processor in response to the selection of the link. In step 606, the authorization processor determines a level of access available for the content by comparing the at least one access characteristic and the at least one user characteristic in the request signal with a source of content specific authentication information including data representing content-specific access levels. Access is provided, via an internet interface, to the requested content on an output device in accordance with the determined level of access in step 608. The level of access granted to the requesting user may include at least one of (a) full access to the content; (b) restricted access to the content and (c) no access to the content. Additionally, the at least one access characteristic identifies the content as being at least one of (a) freely accessible; (b) accessible as part of a subscription service; (c) accessible by a fee-based arrangement.

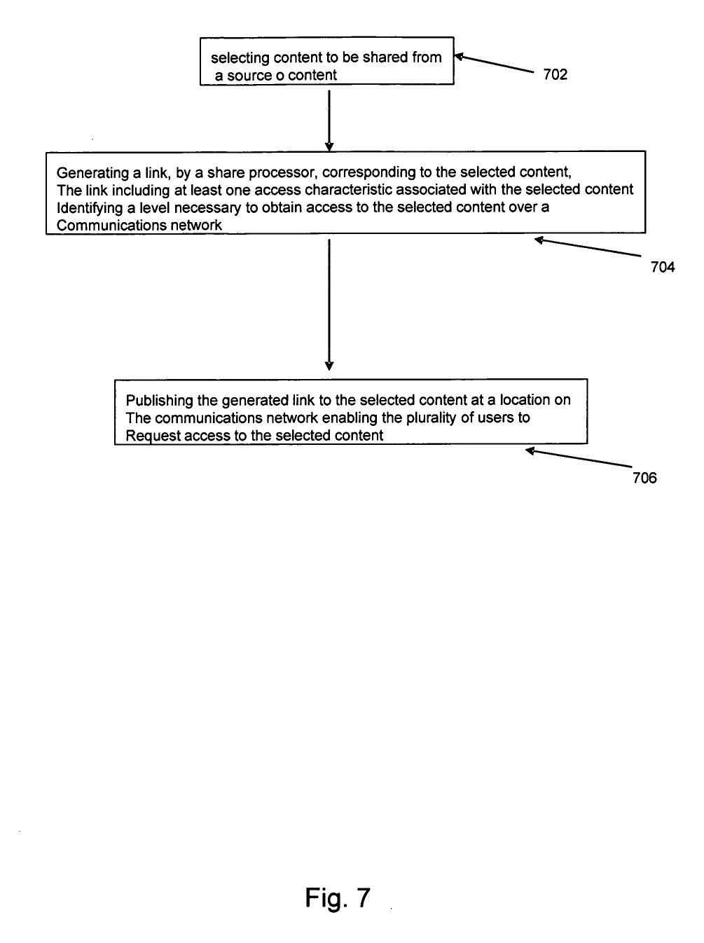

FIG. 7 is exemplary operational algorithm implemented by the system that enables sharing of content between a plurality of users over a communications network. In step 702, content to be shared is selected from a source of content. In step 704, a link is generated by a share processor that corresponds to the selected content. The link including at least one access characteristic associated with the selected content identifying a level necessary to obtain access the selected content over a communications network. In step 706, the generated link to the selected content is published at a location on the communications network enabling the plurality of users to request access to the selected content. The level of access includes at least one of (a) full access to the content; (b) restricted access to the content and (c) no access to the content. In a further embodiment, the link further includes data identifying the content as being at least one of (a) freely accessible; (b) accessible as part of a subscription service; (c) accessible by a fee-based arrangement.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms (for example, a hardware apparatus, hardware and software apparatus, or a computer-readable media). An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method performed by an apparatus for sharing content between a plurality of users over a communications network, the method comprising:
receiving a request signal for a link to content selected by a user, the content being displayed on a primary display device and the request signal including at least one access characteristic associated with the content identified by the link and at least one user characteristic associated with the requesting user over the communications network for receipt by an authorization processor;
determining, by the authorization processor, a level of access available to the user for the content by comparing said at least one access characteristic and said at least one user characteristic in the request signal with content specific authentication information including data representing content-specific access levels; and
providing access, via an internet interface, to the requested content on an secondary display device in accordance with the determined level of access.

2. The method of claim 1, wherein
the level of access includes at least one of (a) full access to the content; (b) restricted access to the content and (c) no access to the content.

3. The method of claim 1, wherein
the at least one access characteristic identifies the content as being at least one of (a) freely accessible; (b) accessible as part of a subscription service; (c) accessible by a fee-based arrangement.

4. The method of claim 1, wherein
the at least one user characteristic includes information identifying content available from content providers that the user is able to access.

5. The method of claim 1, wherein
the at least one user characteristic includes an user-specific identifier for determining the level of access to be provided to the requesting user.

6. The method of claim 1, wherein
the determined access level provides less than full access to the requested content, further comprising the activity of
providing access to a portion of the requested content to the requesting user.

7. The method of claim 6, further comprising the activity of
generating a message including information enabling the requesting user to obtain full access to the requested content; and
transmitting the message to the requesting user.

8. The method of claim 1, wherein
the at least one access characteristic includes information identifying at least one type of device on which the content may be accessed and further comprising the activity of
providing access to the requested content on the at least one device using the access characteristic information.

9-16. (canceled)

17. A method performed by an apparatus for sharing content between a plurality of users over a communications network comprising the activities of:
selecting content to be shared from a source of content, the content being displayed on a primary display device;
generating a link, by a share processor, corresponding to the selected content, the link including at least one access characteristic associated with the selected content identifying a level necessary to obtain access the selected content over a communications network;
publishing the generated link to the selected content at a location on the communications network enabling the plurality of users to request access to the selected content, the published link being viewable on a secondary display device.

18. The method of claim 17, wherein
the level of access includes at least one of (a) full access to the content; (b) restricted access to the content and (c) no access to the content.

19. The method of claim 17, wherein
the link further comprises data identifying the content as being at least one of (a) freely accessible; (b) accessible as part of a subscription service; (c) accessible by a fee-based arrangement.

20. The method of claim 17, wherein
the level provides less than full access to the requested content, and further comprising the activity of
providing access to a portion of the requested content to the requesting user.

21. The method of claim 20, further comprising the activity of
generating a message including information enabling the requesting user to obtain full access to the requested content in response to receipt of a request signal from a user having less than full access to the requested content; and
transmitting the message to the requesting user.

22. The method of claim 1, wherein
the at least one access characteristic includes information identifying at least one type of device on which the content may be accessed.

23. A system for enabling access to shared content over a communications network comprising:
a share processor that generates a link corresponding to content selected by a user to be shared over a communications network, the content being displayed on a primary display device and the link includes at least one access characteristic associated with the selected content identifying a level necessary to obtain access to the selected content over a communications network;
an interne interface coupled to the share processor that publishes the generated link to the selected content at a location on the communications network enabling the plurality of users to request access to the selected content, the published link being displayed on a secondary display device.

24. The system of claim 23, wherein
the level of access includes at least one of (a) full access to the content; (b) restricted access to the content and (c) no access to the content.

25. The system of claim 23, wherein
the link further comprises data identifying the content as being at least one of (a) freely accessible; (b) accessible as part of a subscription service; (c) accessible by a fee-based arrangement.

26. The system of claim 23, wherein
the level provides less than full access to the requested content, and said share processor provides access to a portion of the requested content to the requesting user via the internet interface.

27. The system of claim 26, further comprising
an authorization processor coupled to said share processor that generates a message including information enabling the requesting user to obtain full access to the requested content in response to receipt of a request signal from a user having less than full access to the requested content and transmits transmitting the message to the requesting user via the internet interface.

28. The system of claim 23, wherein
the at least one access characteristic includes information identifying at least one type of device on which the content may be accessed.
